(19) United States
(12) Patent Application Publication
(10) Pub. No.: US 2022/0128857 A1
(43) Pub. Date: Apr. 28, 2022

(54) LIQUID CRYSTAL DISPLAY DEVICE

(71) Applicant: Japan Display Inc., Tokyo (JP)

(72) Inventors: Yosuke HYODO, Tokyo (JP); Toshiyuki HIGANO, Tokyo (JP)

(73) Assignee: Japan Display Inc., Tokyo (JP)

(21) Appl. No.: 17/646,879

(22) Filed: Jan. 4, 2022

Related U.S. Application Data
(63) Continuation of application No. PCT/JP2020/024094, filed on Jun. 19, 2020.

(30) Foreign Application Priority Data
Jul. 11, 2019 (JP) 2019-129092

(51) Int. Cl. G02F 1/1335

(52) U.S. Cl. CPC G02F 1/133504; G02F 1/133536; G02F 1/133512; G02F 1/133514

(57) ABSTRACT

The purpose of the present invention is to reduce moiré with suppressing a decrease in screen luminance in the liquid crystal display device. A representative structure is as follows. A liquid crystal display device including: a first liquid crystal display panel having a first pixel; a second liquid crystal display panel having a second pixel; a back light; and a diffusion layer disposed between the first liquid crystal display panel and the second liquid crystal display panel, in which the second liquid crystal display panel is nearer to the backlight than the first liquid crystal display panel is; a resin light shading film is formed to surround the first pixel in a plan view in the first liquid crystal display panel, and a metal light shading film is formed to surround the second pixel in a plan view in the second liquid crystal display panel.

The present application is a continuation application of International Application No. PCT/JP2020/024094, filed on Jun. 19, 2020, which claims priority to Japanese Patent Application No. 2019-129092, filed on Jul. 11, 2019. The contents of these applications are incorporated herein by reference in their entirety.

### BACKGROUND OF THE INVENTION

### (1) Field of the Invention

The present invention relates to a display device using a display panel and a light control panel, and more particularly, to a display device capable of improving contrast and preventing moiré.

### (2) Description of the Related Art

Liquid crystal display devices have been used in various fields because they can be thin and light and can form high-definition images. However, since the liquid crystal display device uses a backlight for display, compared with an organic EL display device or the like which is a self-luminous display device, an improvement in contrast is a problem.

In addition to an image display panel, a technique using a light control panel has been proposed in order to enhance contrast in a liquid crystal display device. The light control panel has the same configuration as that of the liquid crystal display panel, but does not perform color display and only controls the gradation of transmitted light. However, when the liquid crystal display panel and the light control panel are used in an overlapping manner, moiré is generated due to interference between the non-transparent regions such as the black matrix and the signal lines.

Patent Document 1 discloses a configuration in which a diffusion film is disposed between a display panel and a light control panel to reduce moiré in a liquid crystal display device using a display panel and a light control panel. In addition, Patent Document 1 describes a configuration in which the influence of parallax is reduced by defining the thickness of a substrate constituting a liquid crystal display panel or a light control panel and the thickness of a film.

### PRIOR TECHNICAL DOCUMENT

### Patent Document

Patent document 1: Japanese patent application laid open No. 2018-18043A

### SUMMARY OF THE INVENTION

In a system for improving the contrast of an image using a liquid crystal display panel and a light control panel, moiré generated by interference between the liquid crystal display panel and the light control panel becomes a problem. By arranging optical sheets such as diffusion sheets between the liquid crystal display panel and the light control panel, such moiré can be reduced.

However, the optical sheet diffuses the light that has passed through the light control panel; therefore, if the effect of the diffusion is too strong, the front luminance decreases. If the diffusion is such that the front luminance does not decrease, the diffusion effect is not enough, and moiré is generated. In other words, there is a trade-off relationship.

It is an object of the present invention to maintain a diffusion effect while suppressing a decrease in front luminance and to reduce moiré in liquid crystal display device.

The present invention overcomes the above problems; a concrete means is as follows.

(1) A liquid crystal display device including:

a first liquid crystal display panel having a first pixel; a second liquid crystal display panel having a second pixel; a back light; and a diffusion layer disposed between the first liquid crystal display panel and the second liquid crystal display panel, in which the second liquid crystal display panel is nearer to the backlight than the first liquid crystal display panel is, a resin light shading film is formed to surround the first pixel in a plan view in the first liquid crystal display panel, and a metal light shading film is formed to surround the second pixel in a plan view in the second liquid crystal display panel.

(2) The liquid crystal display device according to (1), in which the first liquid crystal display panel has a color filter, and the second liquid crystal display panel does not have a color filter.

(3) The liquid crystal display device according to (1), in which a reflection type polarizing plate is disposed between the first liquid crystal display panel and the diffusion layer.

(4) The liquid crystal display device according to (1), in which the first liquid crystal display panel does not have a color filter, and the second liquid crystal display panel does not have a color filter.

(5) The liquid crystal display device according to (1), in which the second liquid crystal display panel has a color filter, and the first liquid crystal display panel does not have a color filter.

### BRIEF DESCRIPTION OF THE DRAWINGS

FIG. 1 is an exploded perspective view of a liquid crystal display device including a liquid crystal display panel, a light control panel, and a backlight;

FIG. 2 is a plan view illustrating an embodiment of moiré;

FIG. 3 is a cross-sectional view illustrating another embodiment of moiré;

FIG. 4 is an exploded perspective view of a liquid crystal display device including a liquid crystal display panel, a diffusion sheet, a light control panel, and a backlight;

FIG. 5 is a cross sectional view of the liquid crystal display device of Embodiment 1;

FIG. 6 is a cross sectional view showing an example of the structure of a diffusion sheet;

FIG. 7 is a detailed cross sectional view of the liquid crystal display device of Example 1;

FIG. 8A is a plan view showing a pixel configuration of a liquid crystal display panel;

FIG. 8B is a plan view showing an example of a pixel configuration of a light control panel;

FIG. 9 is a cross-sectional view showing a configuration of Embodiment 2; and

FIG. 10 is a cross-sectional view showing a configuration of Embodiment 3.

### DETAILED DESCRIPTION OF THE PREFERRED EMBODIMENTS

The present invention is explained by the following embodiments in detail.

### Embodiment 1

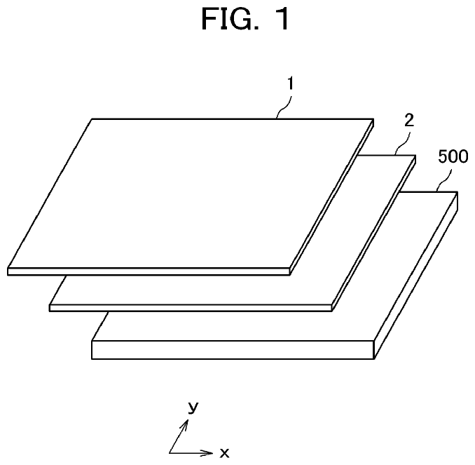

FIG. 1 is an exploded perspective view in which a light control panel 2 is disposed between a liquid crystal display panel 1 and a backlight 500 in order to increase the contrast of an image of the liquid crystal display device. The liquid crystal display panel 1 has a structure as that: a TFT substrate on which a scanning line, a video signal line, a TFT (Thin Film Transistor), a pixel electrode, and the like are formed, and a counter substrate on which a black matrix and a color filter are formed, are bonded to each other by a sealant.

The scanning lines extend in the lateral direction (x-direction) and are arranged in the vertical direction (y-direction), and the video signal lines extend in the vertical direction (y-direction) and are arranged in the horizontal direction. A region surrounded by a scanning line and a video signal line is a pixel; and a TFT and a pixel electrode and the like exist in the pixel.

A black matrix is formed in a grid pattern on the counter substrate so as to overlap with the scanning line and the video signal line, and a color filter for forming a color image is formed in an area surrounded by the black matrix. The black matrix performs a division of pixels and suppresses reflection of external light to enhance the contrast of an image.

The light control panel 2 has basically the same configuration as the liquid crystal display panel 1. However, since the light control panel 2 is intended to control brightness and there is no need to form a color image, a color filter is not necessary. However, other configurations are substantially the same as those of the liquid crystal display panel 1. In other words, a scanning line and a video signal line are formed on the TFT substrate constituting the light control panel 2, and a black matrix is formed on the counter substrate so as to overlap with a scanning line and a video signal line of the TFT substrate.

In a liquid crystal display device, an image is formed by controlling light from a backlight 500 disposed on a back surface for each pixel.

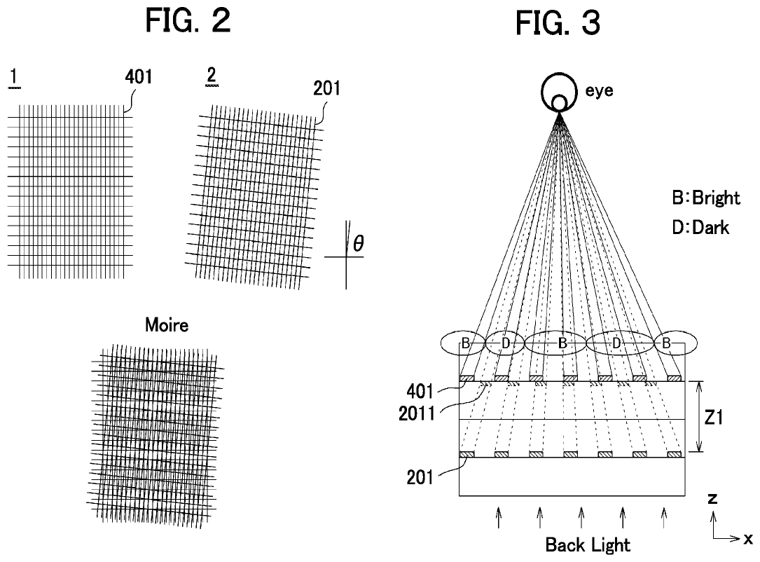

In the configuration shown in FIG. 1, when the liquid crystal display panel 1 and the light control panel 2 are assembled, an assembly error occurs. FIG. 2 is a plan view showing moiré which occurs when the light control panel 2 is combined with the liquid crystal display panel 1 while being shifted by an angle θ. A grid arranged on the upper left of FIG. 2 represents a black matrix 401 formed on a counter substrate of the liquid crystal display panel 1.

The grid arranged on the upper right of FIG. 2 represents a black matrix 201 formed on the counter substrate of the light control panel 2. Due to the assembly error of the liquid crystal display panel 1 and the light control panel 2, the black matrix 201 of the light control panel 2 is inclined by an angle θ with respect to the black matrix 401 of the liquid crystal display panel 1.

When the black matrix 401 of the liquid crystal display panel 1 having such an arrangement and the black matrix 201 of the light control panel 2 having such an arrangement are overlapped, moiré is generated as shown in the lower part of FIG. 2. Such moiré patterns vary depending on the angle θ, and anyway, moiré occurs in any case.

FIG. 3 is a schematic cross-sectional view showing that moiré is generated even when the liquid crystal display panel 1 and the light control panel 2 are assembled almost without errors. In FIG. 3, a black matrix 401 is a black matrix formed on the liquid crystal display panel 1. On the other hand, the black matrix 201 formed on the back is a black matrix formed on the light control panel 2. In FIG. 3, the black matrix 401 and the black matrix 201 are formed at substantially the same position in the lateral direction (x-direction). Therefore, immediately below the eye, the black matrix 401 and the black matrix 201 overlap. However, when viewing in an oblique direction, since the black matrix 401 and the black matrix 201 are separated by z 1 in the z direction, the black matrix 201 enters the field of view. This is called a parallax effect.

In FIG. 3, an imaginary line 2011 indicates how the black matrix 201 looks at the position of the black matrix 401 in order to easily understand the influence of the parallax effect on the brightness. In FIG. 3, a solid line is a line of sight to the black matrix 401, and a dotted line is a line of sight to the black matrix 201.

In FIG. 3, a portion marked as B (Bright) is a bright portion in which the black matrix is sparse. On the other hand, a portion marked as D (Dark) is a dark portion in which the black matrix is dense.

As shown in FIG. 3, a bright portion and a dark portion occur repeatedly depending on the viewing angle. That is, moiré is generated. That means, even if the liquid crystal display panel 1 and the light control panel 2 are assembled without error, moiré is generated.

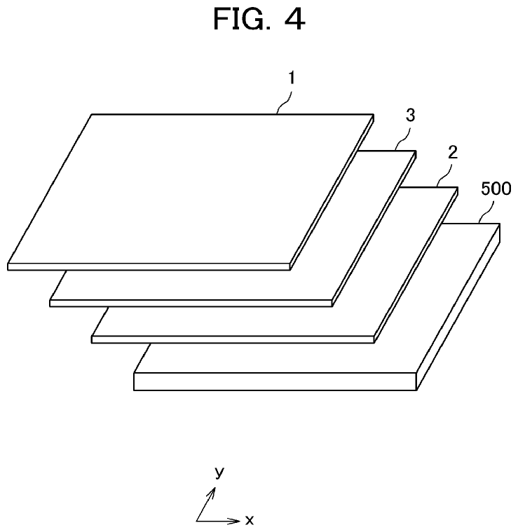

FIG. 4 is an exploded perspective view showing a configuration in which a diffusion sheet 3 is disposed between the liquid crystal display panel 1 and the light control panel 2 to prevent such moiré. The diffusion sheet 3 is arranged between the liquid crystal display panel 1 and the light control panels 2. The diffusion sheet 3 scatters the light that has passed through the light control panel 2 from the backlight 500, and thereby blurs the lattice pattern of, for example, a black matrix of the light control panel 2. Thereby, interference between the lattice pattern of the black matrix of the liquid crystal display panel 1 and the lattice pattern of the light control panel 2 is reduced, and moiré is made inconspicuous.

However, light input to the liquid crystal display panel decreases because the diffusion sheet 3 scatters the light from the back, resulting in a decrease in screen brightness. A haze value is used to express a scattering effect of the diffusion sheet. When the haze value is 80%, for example, only 80% of the light from the back of the diffusion sheet 3 passes. In other words, the larger the haze value, the more suppressed the moiré, but the lower the screen luminance. On the other hand, if the haze value of the diffusion sheet 3 is reduced in order to maintain the screen luminance, it is impossible to sufficiently measure moiré.

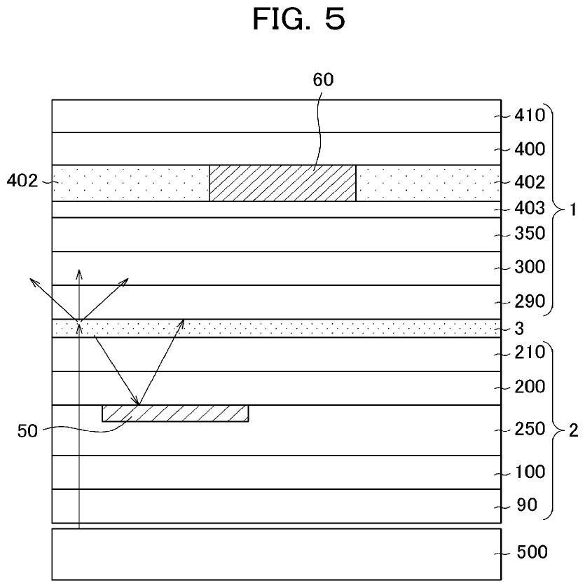

FIG. 5 is a sectional view showing the present invention which solves the above explained problem. In the feature of FIG. 5, the black matrix 50 in the light control panel 3 is formed of metal or an alloy, and light reflected from the diffusing sheet 3 to the back is directed toward the screen direction again, thereby suppressing reduction in the screen brightness.

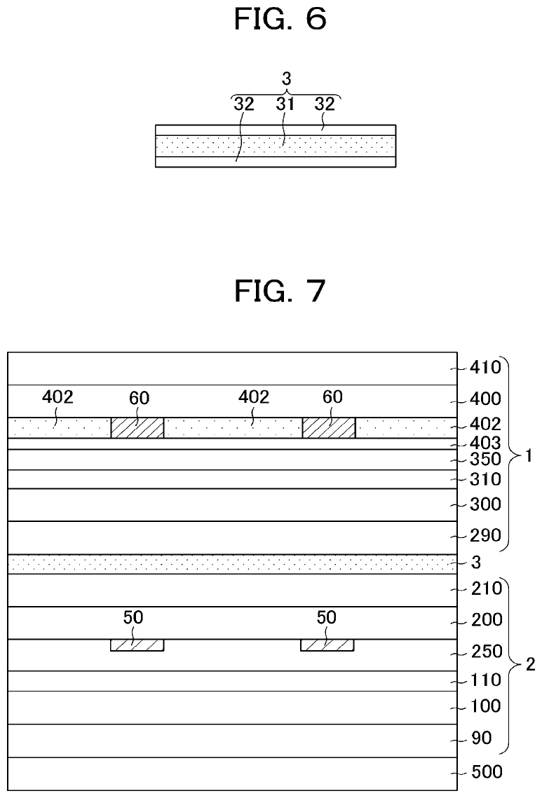

In FIG. 5, a light control panel 2 and a liquid crystal display panel 1 are disposed on a backlight 500. The light control panel 2 and the liquid crystal display panel 1 are bonded via the diffusion sheet 3. The diffusion sheet 3 has a structure as shown in FIG. 6; a haze sheet 31 having a predetermined haze value is sandwiched between an adhesive material 32. That is, it has a structure such as a double-sided bonding tape. A thickness of the diffusion sheet 3 is generally about 0.3 mm, for example. Note that the diffusion sheet 3 is not limited to FIG. 6, and can be, for example, an adhesive sheet having a predetermined haze value formed by mixing fine particles that scatter light in an adhesive layer.

Referring back to FIG. 5, the light control panel 2 has substantially the same configuration as a normal liquid crystal display panel, and a liquid crystal 250 is sandwiched between a TFT substrate 100 and a counter substrate 200. Since the liquid crystal 250 can control only polarized light, a first polarizing plate 90 is disposed on the back surface of the TFT substrate 100, and a second polarizing plate 210 is disposed on the front surface of the counter substrate 200. The polarization axis of the first polarizing plate 90 and the polarizing axis of the second polarizing plate 210 are, for example, in a crossed Nicols relationship, that is, 90 degrees.

A feature of the present invention is that a light shading film is formed of a metal or an alloy (hereinafter, referred to as metal) and a metal black matrix 50 is formed on the counter substrate 200 of the light control panel 2. As the metal material, it is possible to use Cr, MoW, Ti, and the like as well as Al and the like. In other words, a material used for wirings and electrodes for forming a liquid crystal display device can be used. Although the thickness of the metal black matrix 50 is, for example, about 200 nm, it may be thinner as long as the reflectance of the metal black matrix 50 can be secured. The action of the metal black matrix 50 formed on the light control panel 2 will be described later.

In FIG. 5, the liquid crystal display panel 1 for displaying an image is adhered on the diffusion sheet 3. The liquid crystal display panel 1 has the same configuration as that of an ordinary liquid crystal display panel. That is to say, a liquid crystal 350 is sandwiched between a TFT substrate 300 on which a scanning line, a video signal line, a TFT, a pixel electrode, and the like are formed, and a counter substrate 400 on which a color filter 402, a resin black matrix 60, an overcoat film 403, and the like are formed. The overcoat film 403 prevents the pigment constituting the color filter 402 from exuding into the liquid crystal 350. A third polarizing plate 290 is stuck on the back surface of the TFT substrate 300, and a fourth polarizing plate 410 is stuck on the front surface of the counter substrate 400. The polarization axis of the third polarizing plate 290 and the polarizing axis of the fourth polarizing plate 410 have an angle of, for example, 90 degrees to each other. Note that the polarization axis of the second polarizing plate 210 of the light control panel 2 and the polarizing axis of the third polarizing plate 290 of the liquid crystal display panel have the same direction.

A resin black matrix 60 and a color filter 402 are formed on a counter substrate 400 of a liquid crystal display panel 1. A resin black matrix 60 is used as a black matrix of the liquid crystal display panel 1. The resin black matrix 60 is formed by dispersing a black pigment or the like in a resin, and has a thickness of generally 1 μm or more. It is one of important roles of the black matrix to suppress reflection of external light; the resin black matrix 60 is advantageous in that the reflectance is small, and many of the liquid crystal display panels use the resin black matrix 60.

In FIG. 5, light emitted from the backlight and indicated by an arrow passes through the light control panel 2 and enters the diffusion sheet 3. Without the diffusion sheet 3, moiré occurs as described in FIGS. 2 and 3. In FIG. 5, since the light emitted from the light control panel 2 is scattered by the diffusion sheet 3, moiré is reduced. How much moiré is reduced depends on the scattering effect of the diffusion sheet 3, i.e., haze. If the haze value is large, light traveling straight decreases, so that the screen brightness decreases. On the other hand, if the haze value is small, light scattering effect of light is small, so that a sufficient moiré reduction effect cannot be obtained.

A feature of FIG. 5 is that the light reflected by the diffusing sheet 3 is reflected by the metal black matrix 50 and directed toward the screen, thereby suppressing a decrease in the screen brightness. In other words, the larger the scattering effect of the diffusion sheet 3, that is, the larger the haze value, the larger the moiré reduction effect. In the present invention, the haze value of the diffusion sheet 3 is increased to secure the moiré reduction effect, and the reduction of the screen brightness is suppressed by the reflection from the metal black matrix 50 of the light control panel 2. Accordingly, it is possible to reduce moiré while suppressing reduction in screen luminance.

FIG. 7 is a detailed cross-sectional view of FIG. 5. FIG. 7 is different from FIG. 5 in that a cross sectional structure of the light control panel 2 and the liquid crystal display panel 1 is described. In FIG. 7, a TFT circuit layer 110 is formed on the TFT substrate 100 of the light control panel 2. The TFT circuit layer 110 is a layer including a scanning line, a video signal line, a TFT, a pixel electrode, and the like. The metal black matrix 50 is formed on the counter substrate 200 of the light control panel 2, but no color filter is formed. This is because the light control panel 2 is intended to control luminance.

In FIG. 7, a TFT circuit layer 310 is formed on the TFT substrate 300 of a liquid crystal display panel 1. As in the case of the light control panel 2, the TFT circuit layer 310 is a layer including a scanning line, a video signal line, a TFT, a pixel electrode, and the like. The resin black matrix 60 and the color filter 402 are formed on the counter substrate 400 of the liquid crystal display panel 1. This is because the external light reflection is suppressed by the resin black matrix 60 and a color image is formed by the color filter 402. The resin black matrix 60 and the color filter 402 are covered with the overcoat film 403.

In FIG. 7, the metal black matrix 50 formed on the light control panel 2 can be formed very thin as to have a thickness of 200 nm or less. Therefore, a planarization film such as an overcoat film is not required, and an alignment film can be directly formed on the metal black matrix 50. Alternatively, even when a planarization film is formed, the thickness of the planarization film can be extremely thin. In other words, the light control panel 2 of FIG. 7 can maintain a high transmittance of light from the backlight 500.

In FIG. 7, the resin black matrix 60 and the color filter 402 are formed on the counter substrate 400 of the liquid crystal display panel 1. In FIG. 7, the resin black matrix 60 of the liquid crystal display panel 1 and metal black 50 of the light control panel 2 overlap in a plan view. In other words, the same video signal line may be supplied to the liquid crystal display panel 1 and the light control panel 2.

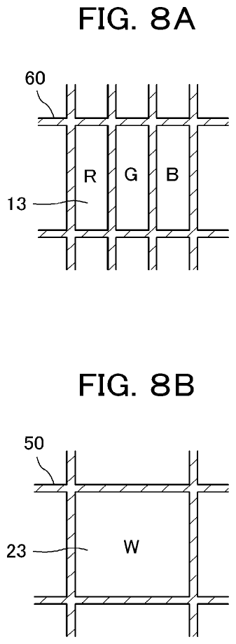

Since the light control panel 2 does not require color display, as shown in FIGS. 8A and 8B, the size of the pixel may be changed between on the side of the liquid crystal display panel 1 and on the side of the light control panel 2. FIG. 8A shows a pixel configuration of the liquid crystal display panel 1. In FIG. 8A, when a red pixel R, a green pixel G, and a blue pixel B are referred to as sub-pixels 13, 1 pixels are formed of 3 sub-pixels in the liquid crystal display panel 1. Each sub-pixel is a hole formed in the resin black matrix 60. Notations R, G, and B in FIG. 8A represent color filters formed in each of the holes 13.

On the other hand, in the light control panel 2, since it is not necessary to form a color image, each pixel 23 is not decomposed into sub-pixels. Each pixel 23 is surrounded by the metal black matrix 50, and no color filter is formed therein. W shown in FIG. 8B shows that white light of the backlight is transmitted as it is.

When the black matrix formed on the liquid crystal display panel 1 and the black matrix formed on the light control panel 2 have the same regularity, moiré is easily noticeable. Accordingly, by forming each grid of the liquid crystal display panel 1 or the light control panel 2 in a shape deviating from a rectangle or a square, moiré can be made inconspicuous.

In such a case, since the pixel 23 of the light control panel 2 can be larger than the pixel 13 (alternatively called the sub-pixel 13) of the liquid crystal display panel, the degree of freedom in changing the shape of the light-transmitting portion of the pixel is large. In this case, it is preferable to form the pixel 23 (the outer shape of the metal black matrix 50) of the light control panel 2 corresponding to the set of the R, G, and B sub-pixels 13 of the liquid crystal display panel 1 so as not to shift the color of the image.

Referring back to FIG. 7, when external light passes through the liquid crystal display panel 1 and enters the light control panel 2, this external light is reflected by the metal black matrix 50 of the light control panel 2. However, since the external light is scattered by the diffusion sheet 3 in this case, the amount of light reaching the metal black matrix 50 decreases. Further, since the external light reflected by the metal black matrix 50 passes through the diffusion sheet 3 again until it is visually recognized by a human, it is scattered again at this time. Therefore, even if the black matrix 50 of the light control panel 2 is made of metal, the influence on an image due to the reflection of the metal is limited.

As described above, by forming the metal black matrix 50 on the light control panel 2, it is possible to enhance the screen brightness while reducing moiré as described above. Further, an influence on an image of an external light reflection due to a metal black matrix 50 formed on the light control panel 2 is extremely small.

### Embodiment 2

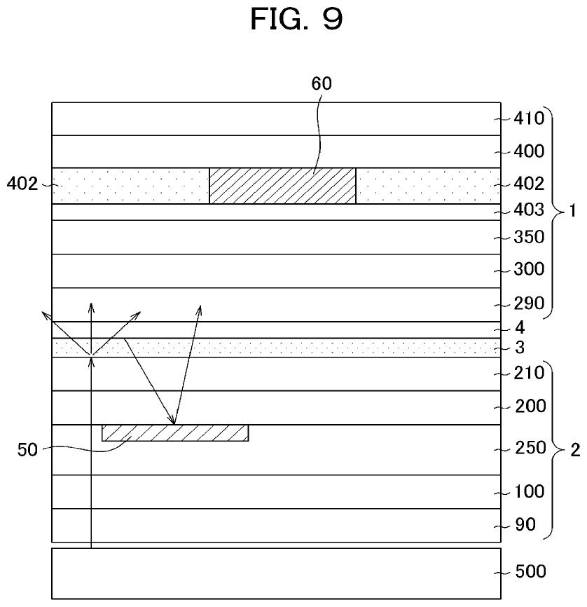

FIG. 9 is a cross-sectional view showing a second embodiment of the present invention. FIG. 9 is different from FIG. 5 of Embodiment 1 in that a polarizing reflection plate 4 is disposed between the diffusion sheet 3 and the liquid crystal display panel 1. The polarizing reflective plate 4 is sold under the trade name of DBEF or APCF. The operation of the polarizing reflection plate 4 is as follows: That is, in the structure of FIG. 5, light incident on the liquid crystal display panel 1 from the backlight 500 passes through the lower polarizing plate 290. At this time, light in the direction of the polarization axis passes, but polarized light in the direction of the absorption axis is absorbed. Thus, only some of the light is used for image formation.

In the structure of FIG. 9, however, the reflective polarizing plate 4 reflects the polarized light, which is to be absorbed in the lower polarizing plate 290 in the structure of FIG. 5, to the back surface. When this reflected light is reflected again at the back of the polarizing reflection plate 4, the phase is inverted by 180 degrees. Thus, this re-reflected light is now able to pass through the lower polarizer 290 to enhance the utilization efficiency of the light.

In this embodiment shown in FIG. 9, the metal black matrix 50 is disposed between the reflective polarizing plate 4 and the backlight 500. A part of the light reflected by the reflection type polarizing plate 4 is reflected immediately without being absorbed by the metal black matrix 50, and the phase is changed by 180 degrees to be incident on the liquid crystal display panel 1. In other words, in the present invention, the metal black matrix 50 arranged on the light control panel 2 has an effect of amplifying the effect of the reflective polarizing plate 4.

Accordingly, in the second embodiment, in addition to the effect described in Embodiment 1, the luminance of the display image of the liquid crystal display panel 1 is improved.

### Embodiment 3

Since the structure of the present invention described in Embodiment 1 and Embodiment 2 can improve contrast while suppressing moiré, it can be used as a medical display, for example. A medical display may be a monochrome display, such as an X-ray photograph. If it is monochrome, it is possible to increase the transmittance and to enhance the contrast by using no color filter.

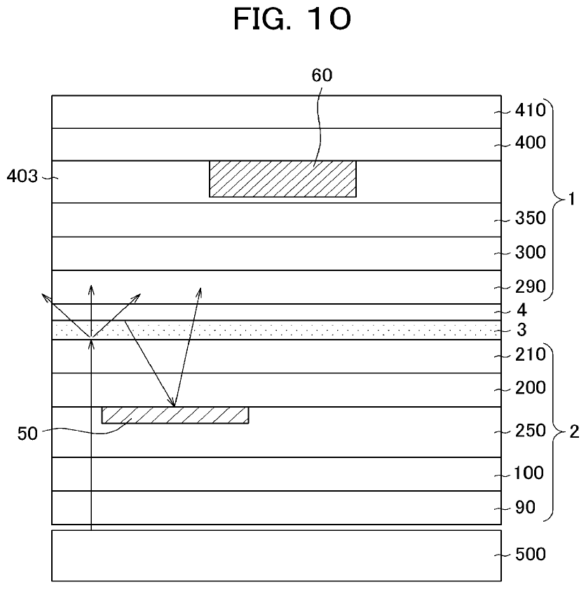

FIG. 10 is a sectional view showing Embodiment 3; FIG. 10 is different from FIG. 5 of Embodiment 1 in that the liquid crystal display panel 1 is not a color display panel but a monochrome display panel. In FIG. 10, the resin black matrix 60 is formed on the counter substrate 400 of the liquid crystal display panel 1, but the overcoat film 403 is formed between the resin black matrices 60 instead of a color filter. Since the overcoat film 403 has high transmittance, a brighter monochrome image can be formed than in the case of FIG. 5 of Example 1.

In the structure of FIG. 10, since a screen luminance is increased, a part of the increment in screen luminance can be turned to reduce moiré by increasing scattering by the diffusion sheet 3, i.e. by increasing a haze value of the diffusion sheet 3. When the haze value of the diffusion sheet 3 increases, the effect of the metal black matrix 50 in the light control panel 2 according to the present invention is further amplified.

As described above, according to the configuration of Embodiment 3, a monochrome image with high contrast can be realized.

What is claimed is:

1. A liquid crystal display device comprising:
a first liquid crystal display panel having a first pixel;
a second liquid crystal display panel having a second pixel;
a back light; and
a diffusion layer disposed between the first liquid crystal display panel and the second liquid crystal display panel,
wherein the second liquid crystal display panel is nearer to the backlight than the first liquid crystal display panel is,
a resin light shading film is formed to surround the first pixel in a plan view in the first liquid crystal display panel, and
a metal light shading film is formed to surround the second pixel in a plan view in the second liquid crystal display panel.

2. The liquid crystal display device according to claim 1,
wherein the first liquid crystal display panel has a color filter, and
the second liquid crystal display panel does not have a color filter.

3. The liquid crystal display device according to claim 1,
wherein an area of the first pixel is smaller than an area of the second pixel.

4. The liquid crystal display device according to claim 1,
wherein a shape of the first pixel is different from a shape of the second pixel.

5. The liquid crystal display device according to claim 1,
wherein a thickness of the metal light shading layer is 200 nm or less.

6. The liquid crystal display device according to claim 1,
wherein a flattening film is not formed in an area surrounded by the metal light shading layer.

7. The liquid crystal display device according to claim 1,
wherein a reflection type polarizing plate is disposed between the first liquid crystal display panel and the diffusion layer.

8. The liquid crystal display device according to claim 1,
wherein the first liquid crystal display panel does not have a color filter, and
the second liquid crystal display panel does not have a color filter.

9. The liquid crystal display device according to claim 8,
wherein an area of the first pixel is smaller than an area of the second pixel.

10. The liquid crystal display device according to claim 8,
wherein a reflection type polarizing plate is disposed between the first liquid crystal display panel and the diffusion layer.

11. The liquid crystal display device according to claim 10,
wherein each the resin light shading layer and the metal light shading layer is formed linear extending in a first direction and extending in a second direction which is orthogonal to the first direction.

12. The liquid crystal display device according to claim 1,
wherein the first liquid crystal display panel has a first substrate, a second substrate, and a first liquid crystal layer sandwiched between the first substrate and the second substrate,
the second liquid crystal display panel has a third substrate, a fourth substrate, and a second liquid crystal layer sandwiched between the third substrate and the fourth substrate,
the second substrate is nearer to the backlight in the first liquid crystal display panel,
the fourth substrate is nearer to the backlight in the second liquid crystal display panel, and
the resin light shading film is formed on the first substrate, and the metal light shading film is formed on the second substrate.
